(19) United States
(12) Patent Application Publication
(10) Pub. No.: US 2018/0364709 A1
(43) Pub. Date: Dec. 20, 2018

(54) AUTONOMOUS DRIVING CONTROL APPARATUS FOR VEHICLE, AUTONOMOUS DRIVING CONTROL METHOD FOR VEHICLE, AND VEHICLE SYSTEM

(71) Applicants: Hyundai Motor Company, Seoul (KR); Kia Motors Corporation, Seoul (KR)

(72) Inventors: Tae Sung Choi, Hwaseong-si (KR); Dong Hwi LEE, Suwon-si (KR); Keon Yup CHU, Suwon-si (KR); Su Jung YOO, lncheon (KR)

(73) Assignees: Hyundai Motor Company, Seoul (KR); Kia Motors Corporation, Seoul (KR)

(21) Appl. No.: 15/728,255

(22) Filed: Oct. 9, 2017

(30) Foreign Application Priority Data
Jun. 16, 2017 (KR) 10-2017-0076850

(51) Int. Cl. G05D 1/00; B60W 50/08; B60W 30/12

(52) U.S. Cl. CPC G05D 1/0061; B60W 50/082; B60W 2540/18; G05D 2201/0213; B60W 2540/04; B60W 30/12

(57) ABSTRACT

A autonomous driving control apparatus may include a determination device that determines whether a mode switch event occurs to set a driving mode of the vehicle to a first mode or a second mode, a route generation device that sets a destination in a case that the first mode is set as the driving mode and generates a driving route based on the set destination, and a driving control device that controls an autonomous driving of the vehicle based on the generated driving route in the case that the first mode is set as the driving mode and to control the driving of the vehicle while maintaining a current driving lane in the case that the second mode is set as the driving mode.

### CROSS-REFERENCE TO RELATED APPLICATION

The present application is based on and claims the benefit of priority to Korean Patent Application No. 10-2017-0076850, filed on Jun. 16, 2017, the entire contents of which is incorporated herein for all purposes by this reference.

### BACKGROUND OF THE INVENTION

### Field of the Invention

The present invention relates to an autonomous driving control apparatus for a vehicle, an autonomous driving control method for the vehicle, and a vehicle system.

### Description of Related art

An autonomous driving system controls an autonomous vehicle on the basis of a driving route and a driving strategy determined with respect to a set destination.

Meanwhile, there are situations in which the driver wants to take a different route other than the driving route determined by the autonomous driving system and arbitrarily changes lanes while traveling along the predetermined driving route.

In a conventional autonomous driving system, However, the driving strategy of the autonomous vehicle is not clearly established for the following cases including when the driver arbitrarily changes lanes or the vehicle leaves a global path while driving autonomously. Accordingly, the conventional autonomous driving system attempts to control the autonomous vehicle along the initially set driving route or switches the driving mode to a manual mode while ignoring the intention of the driver.

The information disclosed in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present invention are directed to providing an autonomous driving control apparatus for a vehicle, which is configured for controlling the vehicle by taking into account a driver's intention in a case that the vehicle leaves its route by the driver's intention while the vehicle runs in an autonomous driving mode along a predetermined route and a predetermined driving strategy, an autonomous driving control method for the vehicle, and a vehicle system.

The technical problems to be solved by the present inventive concept are not limited to the aforementioned problems, and any other technical problems not mentioned herein will be clearly understood from the following description by those skilled in the art to which the present invention pertains.

According to various aspects of the present invention, an autonomous driving control apparatus for a vehicle includes a determination device that determines whether a mode switch event occurs to set a driving mode of the vehicle to a first mode or a second mode, a route generation device that sets a destination in a case that the first mode is set as the driving mode and generates a driving route based on the set destination, and a driving control device that controls an autonomous driving of the vehicle based on the generated driving route in the case that the first mode is set as the driving mode and controls the driving of the vehicle while maintaining a current driving lane in the case that the second mode is set as the driving mode.

The mode switch event is generated by a driver's operation.

The mode switch event is generated corresponding to the second mode in a case that the vehicle leaves its target lane of the driving route as a driver operates a steering wheel during the first mode.

The mode switch event is generated by operating a mode switch button corresponding to the first mode or the second mode.

The route generation device regenerates the driving route based on a predetermined destination with respect to a current location of the vehicle in a case that a mode switch event occurs with respect to the first mode during the second mode.

The mode switch event is generated by operating a mode switch button corresponding to the first mode during the second mode.

In a case that the second mode is switched to the first mode, the driving control device controls the autonomous driving of the vehicle based on the regenerated driving route.

The route generation device determines a target lane and a driving speed of the vehicle based on the generated driving route.

According to various aspects of the present invention, an autonomous driving control method for a vehicle includes determining whether a mode switch event occurs to set a driving mode of the vehicle to a first mode, setting a destination in a case that the first mode is set as the driving mode to generate a driving route based on the set destination, controlling an autonomous driving of the vehicle based on the generated driving route, determining whether a mode switch event corresponding to a second mode occurs to set the driving mode of the vehicle to the second mode, and controlling the driving of the vehicle while maintaining a current driving lane in the case that the second mode is set as the driving mode.

According to various aspects of the present invention, a vehicle system includes an interface device that receives an instruction from a driver and processes the instruction to display driving state information related to a vehicle through a display screen, and an autonomous driving control apparatus that determines whether a mode switch event occurs to set a driving mode of the vehicle to a first mode or a second mode, controls an autonomous driving of the vehicle based on a driving route generated based on a destination in the case that the first mode is set as the driving mode, and controls the driving of the vehicle while maintaining a current driving lane in the case that the second mode is set as the driving mode.

According to the above, the autonomous driving control apparatus for the vehicle may control the autonomous vehicle by taking into account the driver's intention in the case that the autonomous vehicle leaves its route by the driver's intention while the autonomous vehicle runs in the autonomous driving mode along the predetermined route and the predetermined driving strategy.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a vehicle system to which an autonomous driving control apparatus for a vehicle is applied according to an exemplary embodiment of the present invention;

FIG. 2, FIG. 3A, and FIG. 3B are views illustrating exemplary embodiments to explain an operation of an autonomous driving control apparatus for a vehicle according to an exemplary embodiment of the present invention;

FIG. 4 and FIG. 5 are flowcharts illustrating an autonomous driving control method for the vehicle according to an exemplary embodiment of the present invention; and

FIG. 6 is a block diagram illustrating a configuration of a computing system that executes an autonomous vehicle control method according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present invention.

In describing elements of embodiments of the present invention, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present invention pertains. Such terms as those defined in a generally used dictionary are configured to be interpreted as having meanings equal to the contextual meanings in the relevant field of art, and are not to be interpreted as having ideal or excessively formal meanings unless clearly defined as having such in the present application.

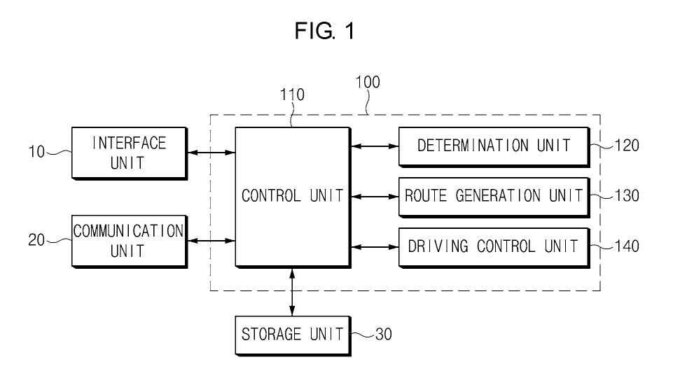

FIG. 1 is a block diagram illustrating a vehicle system to which an autonomous driving control apparatus for a vehicle is applied according to an exemplary embodiment of the present invention.

Referring to FIG. 1, the vehicle system according to an exemplary embodiment of the present invention may include an interface device 10, a communication device 20, a storage device 30, and an autonomous driving control apparatus 100 for the vehicle.

The interface device 10 may include an input device to receive control instructions and an output device to output an operation state and result of the autonomous driving control apparatus 100 for the vehicle.

Here, the input device may include a key button, a mouse, a joystick, a jog shuttle, a stylus pen, and the like. In addition, the input device may include a soft key implemented on a display.

As an example, the input device may include a mode switch button corresponding to a driving mode of the vehicle, e.g., a first mode, a second mode, and a third mode.

The output device may include the display and a voice output device, including a speaker. The display may display a driving state information screen provided by the autonomous driving control apparatus 100 of the vehicle.

In a case that a touch detector, e.g., a touch film, a touch sheet, a touch pad, etc., is disposed in the display, the display may operate as a touch screen, and the input device and the output device may be implemented in an integrated form.

In the instant case, the display may include at least one of a liquid crystal display (LCD), a thin film transistor-liquid crystal display (TFT-LCD), an organic light-emitting diode (OLED), a flexible display, a field emission display (FED), or a three-dimensional (3D) display.

The communication device 20 may include a communication module that supports a communication interface with electrical equipment and control devices included in the vehicle and/or systems provided in the vehicle. For instance, the communication module may transmit the driving state information related to the autonomous driving control apparatus 100 of the vehicle to the interface device 10 and/or the storage device 30. In addition, the communication module may receive location information on destination and information on driving route based on the destination from a navigation device in the vehicle.

In the present embodiment, the communication module may include a module supporting a vehicle network communication including a controller area network (CAN) communication, a local interconnect network (LIN) communication, a Flex-ray communication, etc.

The communication module may include a module for a wireless internet access or a module for a short range communication. As a wireless internet technology, a wireless LAN (WLAN), a wireless broadband (Wibro), a Wi-Fi, a world interoperability for microwave access (Wimax), and the like may be used, and a Bluetooth, a ZigBee, an ultra wideband (UWB), a radio frequency identification (RFID), an infrared data association (IrDA), and the like may be used as a short range communication technology.

The storage device 30 may store data and/or algorithms needed to operate the autonomous driving control apparatus 100 of the vehicle.

As an example, the storage device 30 may include driving mode information. That is, the storage device 30 may store condition information for an operation of a manual driving mode, an autonomous driving mode, and/or a semi-autonomous driving mode. In addition, the storage device 30 may store the information on the destination set in the autonomous driving mode and the driving route information set based on the destination.

In addition, the storage device 30 may store instructions and/or algorithms to control the autonomous driving mode or the semi-autonomous driving mode.

In the exemplary embodiment shown in FIG. 1, the data and/or algorithms used to operate the autonomous driving control apparatus 100 of the vehicle are stored in the storage device 30 of the vehicle system, but a separate storage device may be provided in the autonomous driving control apparatus 100 of the vehicle to store the data and/or algorithms.

In the exemplary embodiment, the storage device 30 may include a storage medium including a random access memory (RAM), a static random access memory (SRAM), a read-only memory (ROM), a programmable read-only memory (PROM), an electrically erasable programmable read-only memory (EEPROM), etc.

When the vehicle is switched to the autonomous driving mode by an input signal from a driver, the autonomous driving control apparatus 100 of the vehicle may automatically control the driving of the vehicle to drive along the driving route set based on the destination input by the driver.

In addition, the autonomous driving control apparatus 100 of the vehicle may switch the driving mode of the vehicle to the semi-autonomous driving mode in a case that a driving lane is changed according to a steering wheel operation by the driver or the mode switch button is operated by the driver while automatically controlling the driving of the vehicle. In the instant case, the autonomous driving control apparatus 100 of the vehicle may maintain the autonomous driving of the vehicle and automatically control the driving of the vehicle with respect to a lane on which the vehicle drives.

The autonomous driving control apparatus 100 of the vehicle may switch the semi-autonomous driving mode to the autonomous driving mode in response to the operation of the mode switch button during the semi-autonomous driving mode and automatically control the driving of the vehicle along the driving route based on the destination.

The autonomous driving control apparatus 100 of the vehicle according to an exemplary embodiment of the present invention may be implemented in the vehicle. In the instant case, the autonomous driving control apparatus 100 of the vehicle may be integrally or monolithically formed with internal control devices of the vehicle or may be connected to the control devices of the vehicle by a separate connection device after being implemented as a separate device. Here, the autonomous driving control apparatus 100 of the vehicle may be operated in conjunction with an engine and a motor of the vehicle or operated in conjunction with a control device that controls an operation of the engine or motor.

In the exemplary embodiment, the autonomous driving control apparatus 100 of the vehicle may include a control device 110, a determination device 120, a route generation device 130, and a driving control device 140. The control device 110 may process signals transmitted between elements of the autonomous driving control apparatus 100 of the vehicle.

The determination device 120 may verify a current driving mode of the vehicle and determine whether a mode switch event occurs. In a case that the mode switch event occurs, the determination device 120 may determine the driving mode of the vehicle as the first mode, the second mode, or the third mode in response to the occurred event.

In the exemplary embodiment, the first mode may indicate the autonomous driving mode, the second mode may indicate the semi-autonomous driving mode, and the third mode may indicate the manual driving mode. In the instant case, different from the autonomous driving mode in which the driving of the vehicle is automatically controlled along the driving route based on the destination, the semi-autonomous driving mode may automatically control the driving of the vehicle, but may control the driving of the vehicle based on a lane on which the vehicle currently drives.

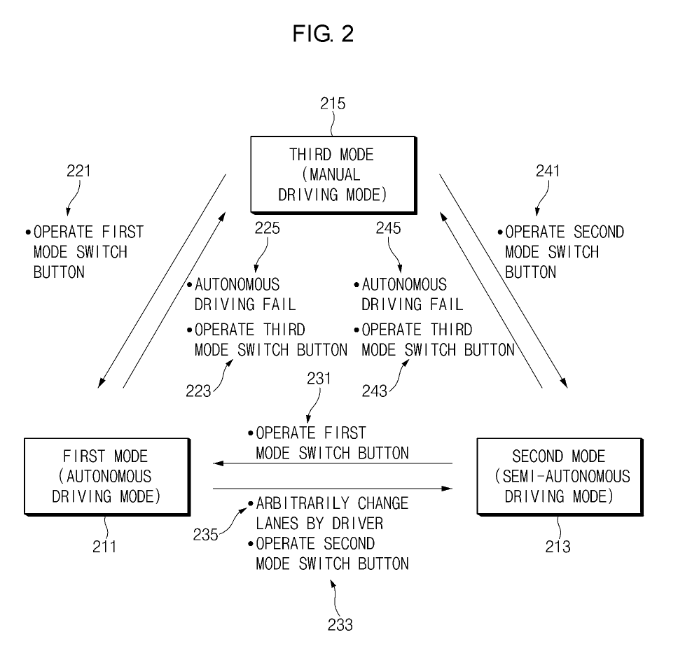

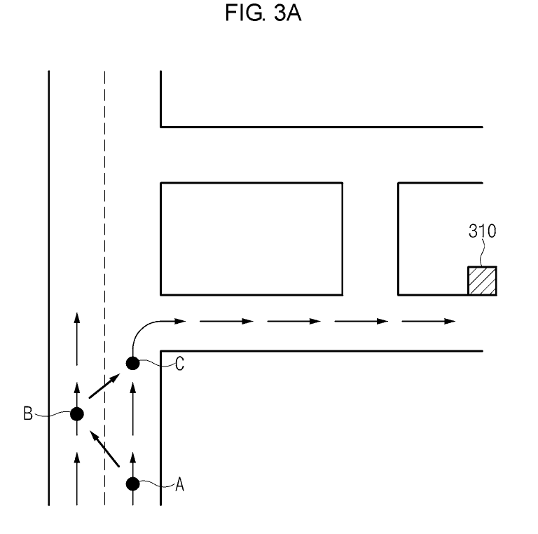

The operation for switching the driving mode of the vehicle depending on the occurrence of the mode switch event will be described in detail with reference to FIG. 2.

Referring to FIG. 2, the mode switch event may occur by a driver's operation. In other words, the mode switch event may occur when a first mode switch button, a second mode switch button, or a third mode switch button is operated.

As an example, when the first mode switch button is operated while the vehicle is operated in a third mode 215 as represented by operation 221 or the first mode switch button is operated while the vehicle is operated in a second mode 213 as represented by operation 231, the determination device 120 may determine the first mode 211 as the driving mode of the vehicle. Accordingly, the control device 110 may switch the driving mode of the vehicle to the first mode 211 depending on the determination of the determination device 120.

In addition, when the second mode switch button is operated while the vehicle is operated in a first mode 211 as represented by operation 233 or the second mode switch button is operated while the vehicle is operated in the third mode 215 as represented by operation 241, the determination device 120 may determine the second mode 213 as the driving mode of the vehicle. Accordingly, the control device 110 may switch the driving mode of the vehicle to the second mode 213 depending on the determination of the determination device 120.

Furthermore, when the third mode switch button is operated while the vehicle is operated in the first mode 211 as represented by operation 223 or the third mode switch button is operated while the vehicle is operated in the second mode 213 as represented by operation 243, the determination device 120 may determine the third mode 215 as the driving mode of the vehicle. Accordingly, the control device 110 may switch the driving mode of the vehicle to the third mode 215 depending on the determination of the determination device 120. Here, in the case that the driving mode of the vehicle is switched to the third mode 215, the control device 110 may terminate the operation of the autonomous driving control apparatus 100.

Meanwhile, the mode switch event may occur in a case that a mode switch (or a mode off) condition is satisfied by the driver's operation.

As an example, in a case that the autonomous driving fails while the vehicle is operated in the first mode 211 as represented by operation 225, the autonomous driving fails while the vehicle is operated in the second mode 213 as represented by operation 245, or the vehicle arrives at the destination, the determination device 120 may determine the third mode 215 as the driving mode of the vehicle. Accordingly, the control device 110 may switch the driving mode of the vehicle to the third mode 215 according to the determination of the determination device 120. Here, in the case that the driving mode of the vehicle is switched to the third mode 215, the control device 110 may terminate the operation of the autonomous driving control apparatus 100.

In addition, in a case that the driving lane is arbitrarily changed as the driver operates the steering wheel while the vehicle is operated in the first mode 211 as represented by operation 235, the determination device 120 may determine the second mode 213 as the driving mode of the vehicle. Accordingly, the control device 110 may switch the driving mode of the vehicle to the second mode 213 according to the determination of the determination device 120.

When the first mode is determined as the driving mode of the vehicle by the determination device 120, the route generation device 130 may set the destination and generate the driving route based on the predetermined destination with respect to a current location of the vehicle. Meanwhile, the route generation device 130 may generate a plurality of routes based on the destination. In the instant case, when one route is selected among the routes by the input from the driver, the route generation device 130 may determine the selected route as the driving route.

In addition, in the case that the driving route is generated (or determined) based on the destination, the route generation device 130 may determine the driving strategy including a target lane, a driving speed, etc.

In the case that the first mode is determined as the driving mode of the vehicle by the determination device 120, the driving control device 140 may control the driving of the vehicle based on the driving route generated (or determined) by the route generation device 130. In the instant case, the driving control device 140 may control the driving of the vehicle based on the determined driving strategy.

Meanwhile, in the case that the second mode is determined as the driving mode of the vehicle by the determination device 120, the driving control device 140 may control the driving of the vehicle while maintaining the lane on which the vehicle currently drives.

As an example, in a case that the vehicle operated in the first mode leaves the driving route or a global path as the driver arbitrarily operates the steering wheel, the driving control device 140 may switch the driving mode of the vehicle to the second mode to maintain the lane on which the vehicle currently drives and to control the driving of the vehicle without attempting to directly return to a target driving route.

In a case that the first mode is determined as the driving mode of the vehicle by the determination device 120 as the mode switch event to the first mode occurs while the driving of the vehicle is controlled by the second mode, the route generation device 130 may regenerate the driving route with respect to the predetermined destination based on the current location of the vehicle. In addition, the route generation device 130 may determine the driving strategy on the driving route which is regenerated.

Accordingly, the driving control device 140 may control the driving of the vehicle based on the driving route and the driving strategy, which are regenerated by the route generation device 130.

FIG. 3A and FIG. 3B are views illustrating exemplary embodiments to explain an operation of an autonomous driving control apparatus for the vehicle according to an exemplary embodiment of the present invention.

FIG. 3A illustrates a driving control operation by a conventional autonomous driving system.

As shown in FIG. 3A, in a case that the lane is arbitrarily changed by the driver at an “A” point and the vehicle reaches at a “B” point while the conventional autonomous driving system controls the autonomous driving of the vehicle with respect to a driving route which is predetermined based on a destination 310 during the first mode, the conventional autonomous driving system may attempt to return to the predetermined driving route.

In the instant case, since a “C” point is at a corner, a quick lane-changing is needed, and thus the vehicle may collide with other vehicles that drive in the target lane.

In addition, the conventional autonomous driving system may not reflect a driver's intention since there is no rule associated with the lane departure even though the vehicle leaves its lane as the driver wants to take another route other than the predetermined driving route.

FIG. 3B illustrates a driving control operation by an autonomous driving control apparatus according to an exemplary embodiment of the present invention.

As shown in FIG. 3B, in a case that the vehicle arrives at a “B” point after the lane is arbitrarily changed at an “A” point by the driver while the autonomous driving control apparatus controls the autonomous driving of the vehicle with respect to a first driving route which is predetermined based on a destination 310 during the first mode, the autonomous driving control apparatus 100 of the vehicle according to an exemplary embodiment of the present invention may switch the driving mode of the vehicle to the second mode to control the autonomous driving of the vehicle with respect to the current driving lane of the vehicle depending on the driver's intention without attempting to return to the predetermined driving route.

As such, in a case that the first mode switch button is operated by the driver when the vehicle arrives at a “D” point, the autonomous driving control apparatus 100 of the vehicle may switch the driving mode of the vehicle to the first mode to generate a second driving route based on the predetermined destination 310 and may control the autonomous driving of the vehicle based on the generated second driving route.

Hereinafter, the operation of the autonomous driving control apparatus according to an exemplary embodiment of the present invention will be described in detail.

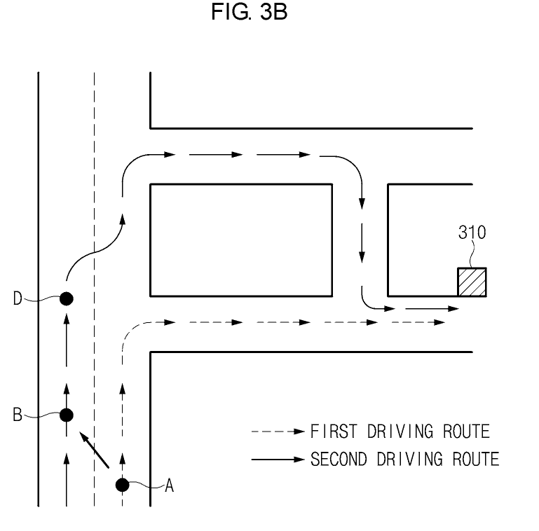

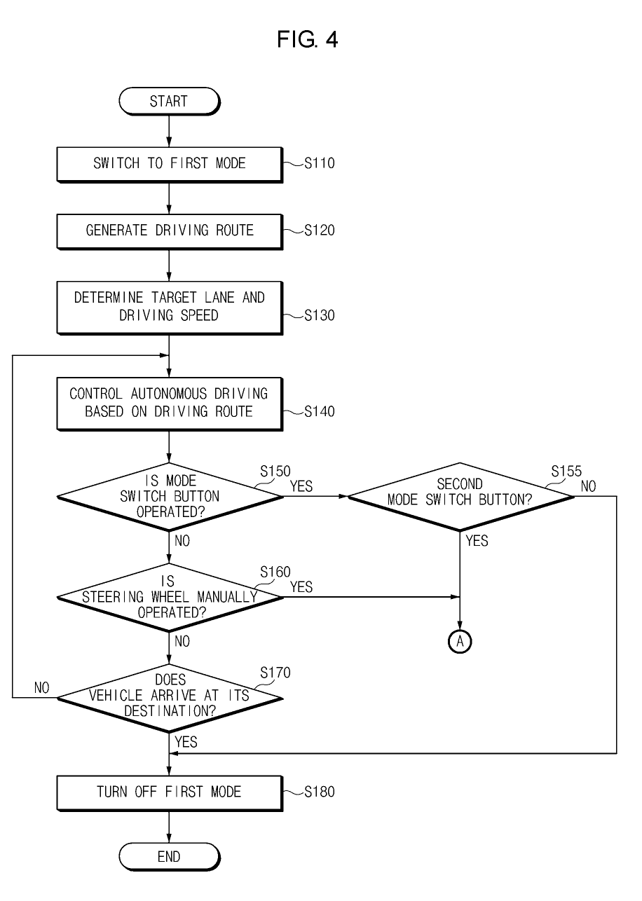

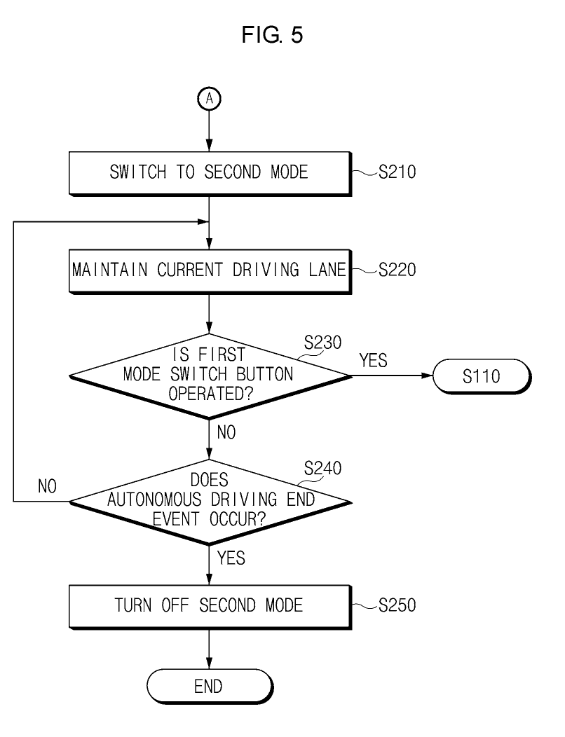

FIG. 4 and FIG. 5 are flowcharts illustrating an autonomous driving control method for the vehicle according to an exemplary embodiment of the present invention.

As shown in FIG. 4, when the driving mode is switched to the first mode, i.e., the autonomous driving mode (S110), the autonomous driving control apparatus 100 of the vehicle may generate the driving route based on the destination input by the user (S120). In addition, the autonomous driving control apparatus 100 of the vehicle may determine the driving strategy including the target lane and the driving speed, based on the driving route generated in operation S120 (S130).

As such, the autonomous driving control apparatus 100 of the vehicle may control the autonomous driving of the vehicle depending on the driving strategy determined in operation S130 based on the driving route generated in operation S120 (S140).

In a case that the mode switch event, for example, the mode switch button is operated (S150) or the steering wheel is manually operated (S160), does not occur, the autonomous driving control apparatus 100 of the vehicle may control the autonomous driving of the vehicle based on the driving route until the vehicle arrives at the destination.

In the case that the vehicle arrives at the destination (S170), the autonomous driving control apparatus 100 of the vehicle may turn off the first mode (S180) and finish the control of the autonomous driving of the vehicle.

Meanwhile, in a case that the second mode switch button is operated by the driver (S150 and S155) or the steering wheel is manually operated by the driver (S160) while the vehicle is in the autonomous driving mode based on the driving route, the autonomous driving control apparatus 100 of the vehicle may carry out operations after “A” of FIG. 5.

In a case that the second mode switch button is operated or the steering wheel is manually operated by the driver's operation, the autonomous driving control apparatus 100 of the vehicle may switch the driving mode of the vehicle to the second mode as shown in FIG. 5 (S210) and may control the autonomous driving of the vehicle while maintaining the current driving lane of the vehicle (S220).

In a case that the first mode switch button is operated by the driver (S230) while the autonomous driving of the vehicle is controlled and the current driving lane is maintained, the autonomous driving control apparatus 100 of the vehicle may carry out operations after operation S110 of FIG. 4. In the instant case, the autonomous driving control apparatus 100 of the vehicle may regenerate the driving route based on the destination by taking into account the current location of the vehicle.

Meanwhile, in a case that an autonomous driving termination event occurs while the autonomous driving of the vehicle is controlled based on the current driving lane (S240), the autonomous driving control apparatus 100 of the vehicle may turn off the second mode (S250) and finish the control of the autonomous driving of the vehicle.

As an example, in a case that the third mode switch button or an accelerator of the vehicle is operated by the driver while the autonomous driving of the vehicle is controlled based on the current driving lane, the autonomous driving control apparatus 100 of the vehicle may turn off the second mode.

The autonomous driving control apparatus 100 operated as described above according to the present embodiment may be implemented in one independent hardware including a memory and a processor processing each operation and may be driven as at least one or more processors while being included in other hardware, e.g., a microprocessor or a general-purpose computer system. In addition, the control device 110, the determination device 120, the route generation device 130, and the driving control device 140 of the autonomous driving control apparatus 100 operated as described above according to the present embodiment may be implemented as one or more processors.

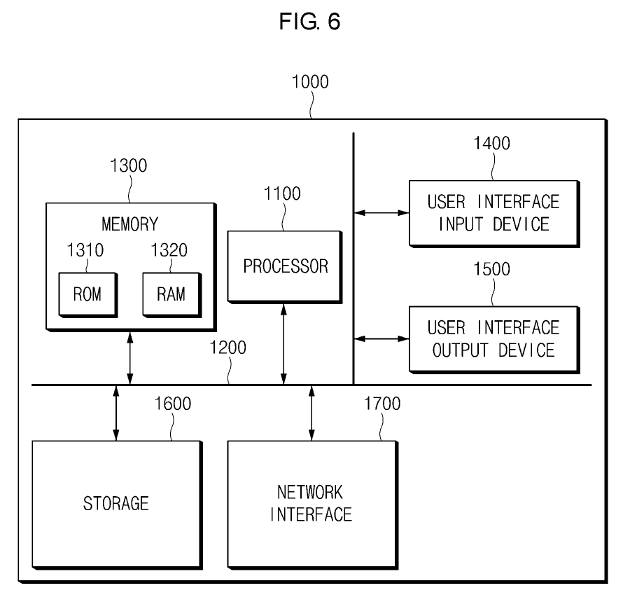

FIG. 6 is a block diagram illustrating a configuration of a computing system that executes the autonomous driving control method of the vehicle according to an exemplary embodiment of the present invention.

Referring to FIG. 6, the computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described with reference to the embodiments included in the specification may be directly implemented with a hardware module, a software module, or combinations thereof, executed by the processor 1100. The software module may reside on a storage medium (i.e., the memory 1300 and/or the storage 1600) including a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The integrated processor and storage medium may reside in an application specific integrated circuit (ASIC). The ASIC may reside in a user terminal. Alternatively, the integrated processor and storage medium may reside as a separate component of the user terminal.

While the present invention has been described with reference to embodiments, it will be apparent to those skilled in the art that various changes and modifications may be made without departing from the spirit and scope of the present invention.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An autonomous driving control apparatus for a vehicle, comprising:
a determination device configured to determine whether a mode switch event occurs to set a driving mode of the vehicle to a first mode or a second mode;
a route generation device configured to set a destination when the first mode is set as the driving mode and to generate a driving route based on the set destination; and
a driving control device configured to control an autonomous driving of the vehicle based on the generated driving route in the case that the first mode is set as the driving mode and to control the driving of the vehicle while maintaining a current driving lane in the case that the second mode is set as the driving mode.

2. The autonomous driving control apparatus of claim 1, wherein the mode switch event is generated by a driver's operation.

3. The autonomous driving control apparatus of claim 2, wherein the mode switch event is generated corresponding to the second mode when the vehicle leaves the vehicle's target lane of the driving route as the driver operates a steering wheel during the first mode.

4. The autonomous driving control apparatus of claim 2, wherein the mode switch event is generated by operating a mode switch button corresponding to the first mode or the second mode.

5. The autonomous driving control apparatus of claim 1, wherein the route generation device is configured to regenerate the driving route based on a predetermined destination with respect to a current location of the vehicle when the mode switch event occurs with respect to the first mode during the second mode.

6. The autonomous driving control apparatus of claim 5, wherein the mode switch event is generated by operating a mode switch button corresponding to the first mode during the second mode.

7. The autonomous driving control apparatus of claim 5, wherein, when the second mode is switched to the first mode, the driving control device is configured to control the autonomous driving of the vehicle based on the regenerated driving route.

8. The autonomous driving control apparatus of claim 1, wherein the route generation device is configured to determine a target lane and a driving speed of the vehicle based on the generated driving route.

9. An autonomous driving control method for a vehicle, comprising:
determining whether a mode switch event occurs to set a driving mode of the vehicle to a first mode;
setting a destination when the first mode is set as the driving mode to generate a driving route based on the set destination;
controlling an autonomous driving of the vehicle based on the generated driving route;
determining whether a mode switch event corresponding to a second mode occurs to set the driving mode of the vehicle to the second mode; and
controlling the driving of the vehicle while maintaining a current driving lane in the case that the second mode is set as the driving mode.

10. The autonomous driving control method of claim 9, wherein the mode switch event is generated by a driver's operation.

11. The autonomous driving control method of claim 10, wherein the determining the first mode includes determining the first mode as the driving mode of the vehicle when a mode switch button corresponding to the first mode is operated.

12. The autonomous driving control method of claim 10, wherein the determining the second mode includes determining the second mode as the driving mode of the vehicle when a mode switch button corresponding to the second mode is operated.

13. The autonomous driving control method of claim 10, wherein the determining the second mode includes determining the second mode as the driving mode of the vehicle when the vehicle leaves the vehicle's target lane of the driving route as the driver operates a steering wheel during the first mode.

14. The autonomous driving control method of claim 9, further including:
regenerating the driving route based on a predetermined destination with respect to a current location of the vehicle when a mode switch event with respect to the first mode occurs during the second mode; and
controlling the autonomous driving of the vehicle based on the regenerated driving route.

15. The autonomous driving control method of claim 9, wherein the mode switch event is generated by operating a mode switch button corresponding to the first mode during the second mode.

16. The autonomous driving control method of claim 9, further including determining a target lane and a driving speed of the vehicle based on the generated driving route.

17. A vehicle system comprising:
an interface device configured to receive an instruction from a driver and process the instruction to display driving state information related to a vehicle through a display screen; and
an autonomous driving control apparatus configured to determine whether a mode switch event occurs to set a driving mode of the vehicle to a first mode or a second mode, control an autonomous driving of the vehicle based on a driving route generated based on a destination in the case that the first mode is set as the driving mode, and control the driving of the vehicle while maintaining a current driving lane in the case that the second mode is set as the driving mode.

18. The vehicle system of claim 17, wherein the mode switch event is generated by the driver's operation.

19. The vehicle system of claim 18, wherein the mode switch event is generated corresponding to the second mode when the vehicle leaves the vehicle's target lane of the driving route as the driver operates a steering wheel during the first mode.

20. The vehicle system of claim 18, wherein the mode switch event is generated by operating a mode switch button corresponding to the first mode during the second mode.
